(19) United States
(12) Patent Application Publication
(10) Pub. No.: US 2016/0292724 A1
(43) Pub. Date: Oct. 6, 2016

(54) SYSTEMS AND METHODS FOR MAXIMIZING MARKETPLACE TRANSACTIONS

(71) Applicants: Jed HOROVITZ, South Harrison Township, NJ (US); Robert Samuel KOLO, Haddonfield, NJ (US); Michele Renee DEVERY, Marlton, NJ (US)

(72) Inventors: Jed HOROVITZ, South Harrison Township, NJ (US); Robert Samuel KOLO, Haddonfield, NJ (US); Michele Renee DEVERY, Marlton, NJ (US)

(21) Appl. No.: 15/083,811

(22) Filed: Mar. 29, 2016

Related U.S. Application Data
(60) Provisional application No. 62/143,595, filed on Apr. 6, 2015.

(51) Int. Cl. G06Q 30/02; G06Q 30/08; H04L 29/08

(52) U.S. Cl. CPC G06Q 30/0247; H04L 67/12; G06Q 30/08

(57) ABSTRACT

A systems and methods for managing a plurality of service provider transactions within an auction/delivery services marketplace defined by multiple rapidly changing criteria is provided. The present invention regularly tests and tracks in real time the available service providers within the auction/delivery to determine their rates of successfully delivering their provided services. These live performance results are continuously fed back into the testing and tracking of the service providers forming a feedback loop for reasonably calculating maximum revenues while balancing multiple rapidly changing criteria when dealing with the plurality of available service providers

### CROSS-REFERENCE TO RELATED APPLICATION

This application claims the benefit of priority of U.S. provisional application No. 62/143,595, filed 6 Apr. 2015, the contents of which are herein incorporated by reference.

### BACKGROUND OF THE INVENTION

The present invention relates to systems and methods for maximizing marketplace transactions and, more particularly, to a system and method for managing a plurality of service provider transactions within an auction/delivery services marketplace defined by multiple rapidly changing criteria through providing a feedback loop to maximize revenue.

Publishers of online content make a return on their investment in the online content by selling and successfully placing advertisements adjacent to and/or in conjunction with said online content. In the context of video advertisement, the process includes the publisher creating an inventory of video advertising opportunities (also known as “impressions”) to be filled with said video advertisements. Such inventory of impressions are expensive to generate and limited in nature, and so successfully selling and filling video advertisement is critical to the financial success of online publishers. Advertisements to fill such impressions are also scarce and come with significant limiting specifications as the result of advertisers' desire to target specific audiences.

As a result, publishers typically need to work with several buyers (direct advertisers and various kinds of advertising networks) to fill their available inventory of impressions. With the advent of interlinked programmatic advertising buying via RTB (real time bidding) marketplaces it is possible (and competitively necessary) for publishers to work with multiple video advertisement sources simultaneously.

In theory, such auction/delivery services are marketplaces designed to serve both buyers and sellers. Typically, however, auction/delivery services favor the advertiser (impression buyer), disadvantaging the publishers. The disadvantages stem generally from the lag time between purchase and delivery, since publishers tend to only get paid on delivery, regularly resulting in the window of opportunity to fill impressions closing before being filled—i.e., the impressions ‘times out’ for “failure to deliver.” Each “failure to deliver” costs seconds which frequently translates into significant lost opportunities for the publisher. One example of the lopsidedness of the existing markets is that re-sellers of advertising opportunities/impressions are able to bid on an impression and monopolize it while shopping for a buyer. If they do not locate a party to resell to, they are able to pass the opportunity/impression back to the auction network without paying the publisher for this option. Since users leave web pages and even sites that do not deliver content quickly publishers lose opportunities, this disadvantage can be a costly.

Another disadvantage is the dearth of information the publishers have about the impression buyers. This is problematic because determining the profitability of different advertisement sources depends on a number of factors, which change in real time. Specifically, the current auction/delivery services do not take into account the externalities that impact the actual functioning of the impression sales and advertisement delivery process such as the time it takes a multi-party auction system to respond, the fluctuating state of supply and demand, complex relationships of various advertiser targeting parameters, daisy chaining of multiple auctions and the refusal of winning bidders to purchase, plus the ability of assigned advertiser to deliver their video advertisement in the proper format (i.e. sound on or off) and in a timely manner. Existing advertisement auction/delivery services generally only offer publishers the ability to monitor results and change settings in real time via a manual interface. As a result, currently advertising is selected based mostly on a theoretical pay rate. This is inefficient at best and useless in an environment that changes by the minute.

As can be seen, there is a need for a system and method for publishers transacting with multiple advertisement sources through an auction/delivery services marketplace by providing real time dynamic management of a plurality of ad sources based on their associated performance data, thereby efficiently determining what ad sources generate the most revenue for the publisher so as to reduce the rate of failure and the amount of time needed to deliver advertisements.

### SUMMARY OF THE INVENTION

In one aspect of the present invention, a computer implemented method for maximizing revenue through an auction/delivery service marketplace includes the steps of: (a) electronically interconnecting a plurality of available service providers and a plurality of client requests, wherein each client request has at least one targeting specification, and wherein each available service provider has a predicted revenue; (b) vetting each available service provider based in part on the targeting specification of a first client request of the plurality of client requests so as to identify a plurality of qualified service provides from the plurality of available service providers; (c) selecting a first qualified service provider of the plurality of qualified service providers based in part on the associated predicted revenue; (d) recalculating the associated predicted revenue of the first qualified service provider based on an amount paid for the first qualified service provider to complete the first client request, wherein the amount paid is zero if the at least one client request is not completed; and (e) repeating steps (c) through (d) in respect of second and/or further client requests of the plurality of client requests.

In another aspect of the present invention, the computer implemented method for maximizing revenue through an auction/delivery service marketplace further includes a database configured to retrievably store the plurality of client requests, the plurality of available service providers, and a plurality of performance metrics associated with each of the plurality of available service providers, wherein the database is configured calculate a success rate for each available service provider of the plurality of service providers, wherein the success rate is equal to a ratio of occurrences of a non-zero amount paid to occurrences of recalculating the associated predicted revenue, wherein the recalculating the associated predicted revenue further includes multiplying the success rate by the amount paid, wherein recalculating the associated predicted revenue and calculating the success rate is done in real time, and wherein for each service provider of the plurality of service providers not having an occurrence of recalculating the associated predicted revenue, the associated predicted revenue equals a theoretical pay rate.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention; and

FIG. 2 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system and method for managing a plurality of service provider transactions within an auction/delivery services marketplace defined by multiple rapidly changing criteria through providing a feedback loop to maximize revenue. The system continually tests and tracks the available service providers within the auction/delivery to determine their rates of successfully delivering their provided services. In the context of publisher-advertiser marketplace, the present invention regularly tests and tracks available advertisement sources (ad sources) to determine their current rates of successfully filling impressions so as to reduce delivery failure and increase revenue for each available impression. The present invention uses actual live performance results to provide a feedback loop to maximize revenue when dealing with the plurality of available service providers and balancing multiple rapidly changing criteria.

The present invention may include at least one computer with a user interface. The computer may include at least one processing unit and a form of memory including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

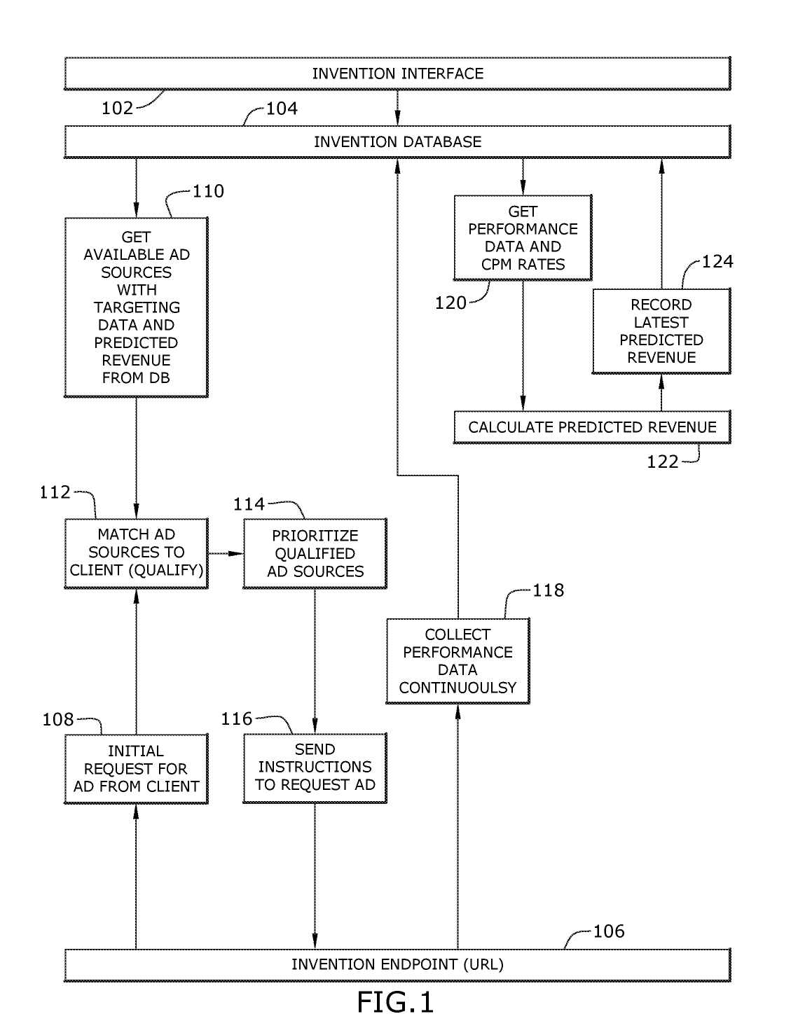

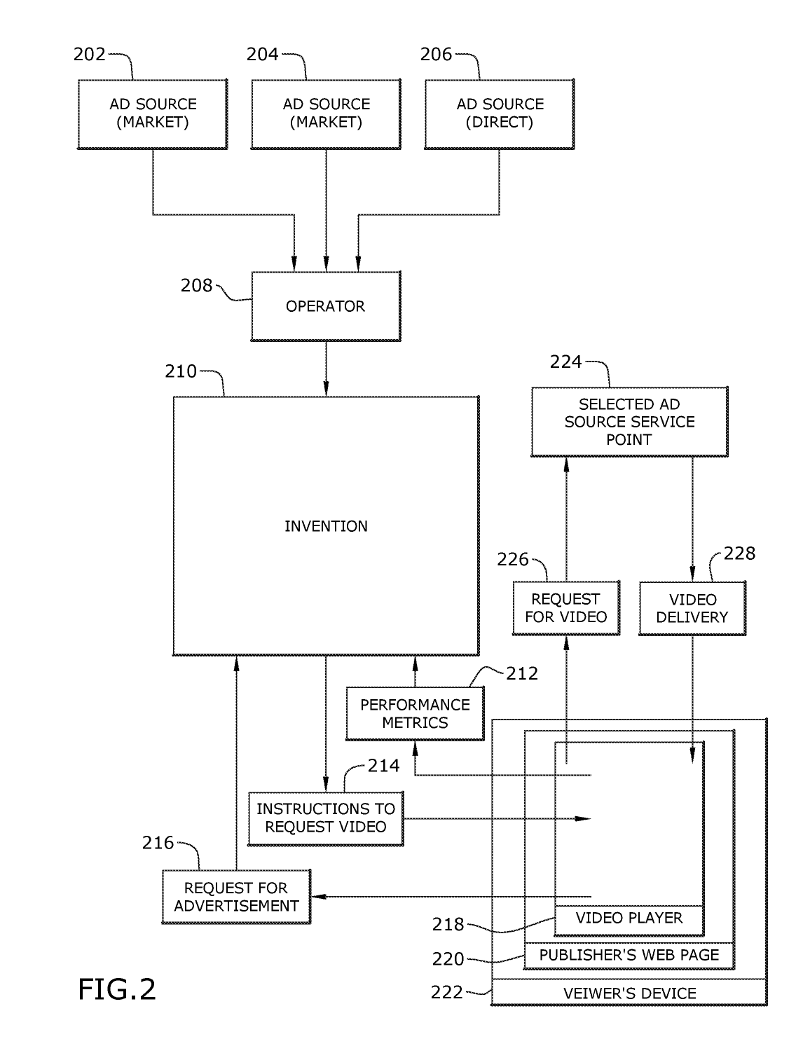

Referring to FIGS. 1 and 2, the revenue maximization system 210 may include an operator 208, an invention interface 102; an invention database 104; an invention endpoint (URL) 106; a client request 108; a plurality of access available ad sources 202, 204 and 206, and performance metrics thereof 212. The present invention may further include functionality for obtaining available ad sources with targeting data and predicted revenue 110; matching ad source to client (target/qualify) 112 adapted to match client request 108 to ad sources 202-206; prioritizing qualified ad sources 114 adapted to pool ad sources 202-206 not disqualified by the matching ad source to client functionality 112; sending instructions to client 116; collecting performance data 118; gathering performance data and CPM rates 120; calculating predicted revenue 122; and recording latest predicted revenue 124.

The invention interface 102 may be adapted to manage the plurality of ad sources 202, 204 and 206. An ad source may be a single advertisement, direct ad source 206, served by the publisher itself or a third party market-based ad source 202, 204, including the advertiser or an advertisement network that manages a collection of advertisers and advertisements via a real time bidding process and which may be linked to additional sources. The invention interface 102 provides a mechanism for the operator 208 to insert data and settings into the invention database 104.

The invention database 104 may include targeting data (geographic, viewer experience limits, publisher limits, ad source limits per day, ad source limits for a date range, ad source limits based on audio off or on, ad source limits based on auto start or user initiated play, ad source limit on specific domains [either prohibited or exclusive lists], ad source limits on viewing device types, and the like); ad source performance metrics 212, ad source CPM rate, and ad source predicted revenue, as well as additional controls can be added as the need arises.

The revenue maximization system 210 may utilize an invention end point 106 in the form of a URL or similar portal adapted to receive and communicate a client request 108 for a service from one of the plurality of service providers on the auction/delivery service marketplace. For example, the client request 108 may be for placing an advertisement on a video player 218 on the publisher's web page 220 for operatively playing on a viewer's device 222. In certain embodiments, the request for video 226 may include a selected ad source service point 224 and video delivery 228 step prior to playing on the video player 218.

The revenue maximization system 210, possibly through the end point 106, may prompt a user-client for a client request 108, and the revenue maximization system 210 may be adapted to bundle several viewer profile information from a previous request of the same user-client. The viewer profile information may include an internet protocol address (IP address), the browser's viewer agent, and any cookie based data of the user-client, and the collecting and bundling of such information may be enabled by the request for advertisement functionality 216. The viewer profile information may be used to perform the targeting as specified by the publisher for each ad source 202-206 in the database 104, where it is retrievably stored by the revenue maximization system 210.

The revenue maximization system 210 is adapted to match properties of the user-client to available ad sources 202-206 through a series of if-then functions, whereby if any of the if-then functions return a value of ‘False’, the associated ad source is eliminated from a pool of qualified ad sources 114 for the respective client request 108, via the matching ad source to client functionality 112. Through this functionality, the revenue maximization system 210 addresses the rapidly changing criteria defined in part by the targeting data mentioned above, which in turn is a reflection of various, constantly changing, advertiser targeting parameters.

The revenue maximization system 210 may be adapted to order the remaining pool of qualified ad sources 114 by predicted revenue, as calculated by the calculating predicted revenue functionality 122. The predicted revenue is a function of ranking qualified ad sources 114 relative to a predetermined percentage of client requests 108. For example, the number one ad source 202-206 may be selected for ninety percent of client requests 108. For the remainder of the remainder (typically 10 percent) one of the lower ranking ad sources 202-206 may be selected at random in order to determine how they will perform in the current environment. The end result is a selected qualified ad source for each client request 108.

The revenue maximization system 210 may be adapted to instruct the user-client, through the sending instructions to client functionality 116, to request a video from the selected qualified ad source through an instructions to request video mechanism 214. The instructions to request video mechanism 214 may include instructions to report performance of the selected qualified ad source to the revenue maximization system 210.

Through the collecting performance data functionality 118, if a video advertisement plays successfully (“ad success”), a notification is sent by the player to the revenue maximization system 210, which stores associated performance data, including but not limited to the publisher, the time of request, and the ad source of the ad success in the invention database 104. In certain embodiments, this notification is triggered by an impression event but will work with any other standards based event defined with video ad serving technology on other platforms.

On a scheduled basis, (for example, every minute) the performance data for each ad source is pulled from the invention database 104. The performance data then utilized by the calculating predicted revenue functionality 122, providing a feedback loop that balances multiple rapidly changing criteria of the targeting data, while maximizing revenue based on the most current performance data.

Referring to FIG. 2, the revenue maximization system 210 interacts with the plurality of ad sources 202-206 as part of a networked environment. Such interaction may be made via HTTP with a VAST (video advertising serving template, but any current or future formats and protocols could be used), XML documents containing instructions on which video advertisement to load, and the like. Flash and/or other player formatting instructions can be included as needed. Also included in this document generated by the present invention are instructions for the player to send impression events back to the revenue maximization system 210 which it records and uses them in the ongoing maximization feedback process described above. Cookies are also delivered to the client-user subsequent targeting for the specific end viewer.

Through the calculating predicted revenue functionality, the present invention may determine performance metrics 212 for a particular ad source for each publisher through the transformation of the ad client request 108 and the ad success into a success rate. The ad successes divided by ad client requests 108 equals the success rate. The product of the success rate and the amount paid (CPM) calculates the predicted revenue. The present invention uses the success rate over a predetermined time horizon (depending on the speed of change in the environment), for example the last hour, to automatically re-determine an updated predicted revenue. The most current predicted revenue is retrievably stored in the invention database 104, and in turn used by the obtaining available ad sources with targeting data and predicted revenue functionality 110.

The revenue maximization system 210 could be created in any number of standard programming languages by following the logic described in the drawings. The key is using recently updated previous performance data to predict current results while regularly sampling the results from new and lower performing ad sources.

The revenue maximization system 210 may perform its functionality only when connected to the clients providing impressions via (212 performance metrics) in real time. The faster the connection, the better the revenue maximization system 210 will function. A rollover function could be added to the revenue maximization system 210 to allow for ad requests to make a second or third ad source if the prior ones fail to deliver in a timely fashion.

The revenue maximization system 210 performs on a continuous data flow in real time so it has no fixed starting point after installation and reordering the functions would not fundamentally improve the Invention.

The method of using the present invention may include the following. The revenue maximization system 210 disclosed above may be provided, for example by loading the appropriate software onto a computer connected to contracted ad sources and clients, typically via the Internet. The operator 208 may enter and update ad source targeting data and profile data including a current payment rate (CPM) for ad impressions. The end point (URL) is provided to client-users, typically in video player code. As ad requests are made, the revenue maximization system 210 prioritizes and selects the best performing ones.

In addition to websites, the present invention could be used for, Apps (mobile applications), Television, Radio or other networked audio/visual medium where impressions are sold to advertisers.

Moreover, the present invention optimizes user experience by increasing the speed of advertisement delivery in a networked environment.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer implemented method for maximizing revenue through an auction/delivery service marketplace, comprising the steps of:
(a) electronically interconnecting a plurality of available service providers and a plurality of client requests, wherein each client request has at least one targeting specification, and wherein each available service provider has a predicted revenue;
(b) vetting each available service provider based in part on the targeting specification of a first client request of the plurality of client requests so as to identify a plurality of qualified service provides from the plurality of available service providers;
(c) selecting a first qualified service provider of the plurality of qualified service providers based in part on the associated predicted revenue;
(d) recalculating the associated predicted revenue of the first qualified service provider based on an amount paid for the first qualified service provider to complete the first client request, wherein the amount paid is zero if the at least one client request is not completed; and
(e) repeating steps (c) through (d) in respect of second and/or further client requests of the plurality of client requests.

2. The method of claim 1, further providing a database electronically connected to a computer, wherein the database is configured to retrievably store the plurality of client requests, the plurality of available service providers, and a plurality of performance metrics associated with each of the plurality of available service providers.

3. The method of claim 2, wherein the computer is configured to calculate a success rate for each available service provider of the plurality of available service providers, wherein the success rate is equal to a ratio of occurrences of a non-zero amount paid to occurrences of recalculating the associated predicted revenue for each respective available service provider.

4. The method of claim 3, wherein the recalculating the associated predicted revenue further includes multiplying the success rate by the amount paid.

5. The method of claim 4, wherein recalculating the associated predicted revenue and calculating the success rate is done in real time.

6. The method of claim 5, wherein for each service provider of the plurality of service providers not having an occurrence of recalculating the associated predicted revenue, the associated predicted revenue equals a theoretical pay rate.

7. The method of claim 6, wherein the revenue being maximized is advertising revenue, wherein each client request is for placing an advertisement on a video player, and wherein the plurality of service providers comprise video advertisement providers.

8. The method of claim 7, wherein the plurality of performance metrics further comprise at least one publisher and a time of request, both associated with each of the plurality of client requests.

9. The method of claim 8, wherein the at least one targeting specification comprises at least one of the following: viewer experience limits, publisher limits, ad source limits per day, ad source limits for a date range, ad source limits based on audio off or on, ad source limits based on auto start or user initiated play, ad source limit on specific domains, or ad source limits on viewing device types.

10. The method of claim 9, wherein the database is configured to determine the success rate as it relates to each of the at least one publisher.
